(19) United States
(12) Patent Application Publication
(10) Pub. No.: US 2022/0080576 A1
(43) Pub. Date: Mar. 17, 2022

(54) MAGNETIC SOCKET HOLDER

(71) Applicant: JEI MOU INDUSTRIAL CO., LTD., Taichung City (TW)

(72) Inventor: Po-Shen Chen, Taichung City (TW)

(21) Appl. No.: 17/534,657

(22) Filed: Nov. 24, 2021

Related U.S. Application Data
(63) Continuation-in-part of application No. 16/828,180, filed on Mar. 24, 2020.

(30) Foreign Application Priority Data
Feb. 10, 2020 (TW) 109104066

(51) Int. Cl. B25H 3/00

(52) U.S. Cl. CPC B25H 3/003

(57) ABSTRACT

A magnetic socket holder includes a base, a bottom board, and a first magnet. The base has a top portion and a bottom portion, a first insertion hole, and a second insertion hole. Each of the first insertion hole and the second insertion hole extends from the top portion towards the bottom portion. The bottom board is mounted to the bottom portion and has a top edge, a bottom edge, and a first recess formed on the top edge. The first magnet is mounted in the first recess and has a first side located between the first insertion hole and the bottom edge and a second side located between the second insertion hole and the bottom edge.

### CROSS-REFERENCE

The present application is a continuation-in-part application of U.S. patent application Ser. No. 16/828,180, filed on Mar. 24, 2020, now pending, of which the entire disclosure is incorporated herein by reference for all purposes.

### BACKGROUND OF THE INVENTION

The present invention relates to a socket holder and, more particularly, to a magnetic socket holder for securely holding and storing sockets.

Taiwan Utility Model No. M424221 discloses an improved structure of a socket holder including a base, a lid, and a plurality of magnets mounted between the base and the lid. The lid is coupled to an inner edge of the base and is suitable for a socket holder without a connecting outer periphery. The plurality of magnets provides magnetic force for attraction to a fixed object made of metal. The lid has a planar outer surface for attraction to the fixed object.

The socket holder includes a plurality of grooves for receiving sockets, with each groove having a flange on an inner periphery thereof for retaining a respective socket, preventing the respective socket from falling out. However, insertion of the respective socket into the respective groove is impeded by the flange, such that the respective socket requires to be forcibly inserted into the respective groove. Furthermore, the flange of the respective groove is apt to wear during use, adversely affecting the holding effect.

Thus, a need exists for a novel magnetic socket holder that mitigates and/or obviates the above drawbacks.

### BRIEF SUMMARY OF THE INVENTION

The primary objective of the present invention is to provide a magnetic socket holder including a base, a bottom board, a first magnet, and a first socket. The base has a top portion and a bottom portion. The top portion includes a first insertion hole and a second insertion hole, and each of the first insertion hole and the second insertion hole extends from the top portion towards the bottom portion and does not penetrate through the bottom portion. The bottom board is mounted to the bottom portion and has a top edge, a bottom edge, and a first recess formed on the top edge and not penetrating the bottom edge. The first magnet is mounted in the first recess and has a first side located between the first insertion hole and the bottom edge, and a second side located between the second insertion hole and the is bottom edge. The first socket is detachably attached in the first insertion hole and has a first connection hole with a first inner wall aligned with the first side of the first magnet in a width direction.

In an example, the magnetic socket holder further includes a second socket detachably attached in the second insertion hole and having a second connection hole with a second inner left wall aligned with the second side of the first magnet in the width direction.

In an example, the top portion further includes a third insertion hole extending from the top portion towards the bottom portion and does not penetrate through the bottom portion. The bottom board further has a second recess formed on the top edge and not penetrating the bottom edge. The magnetic socket holder further includes a second magnet mounted in the second recess and having a third side located between the second insertion hole and the bottom edge and a fourth side located between the third insertion hole and the bottom edge. The second connection hole further has a second inner right wall faced to the second inner left wall and aligned with the third side of the second magnet in the width direction.

In an example, the magnetic socket holder further includes a third socket detachably attached in the third insertion hole and having a third connection hole with a third inner wall aligned with the fourth side of the second magnet in the width direction.

In an example, the first magnet further has a first upper edge, and the second magnet further has a second upper edge. The first upper edge and the second upper edge are configured to flush with the top edge of the bottom board in a height direction.

The present invention will become clearer in light of the following detailed description of illustrative embodiments of this invention described in connection with the drawings.

### DESCRIPTION OF THE DRAWINGS

FIG. 1 is a perspective view of a magnetic socket holder of an embodiment according to the present invention.

FIG. 2 is an exploded, perspective view of the magnetic socket holder of FIG. 1.

FIG. 3 is a cross sectional view of the magnetic socket holder of FIG. 1.

FIG. 4 is another cross sectional view of the magnetic socket holder of FIG. 1.

FIG. 5 is an enlarged view of a portion of FIG. 4.

### DETAILED DESCRIPTION OF THE INVENTION

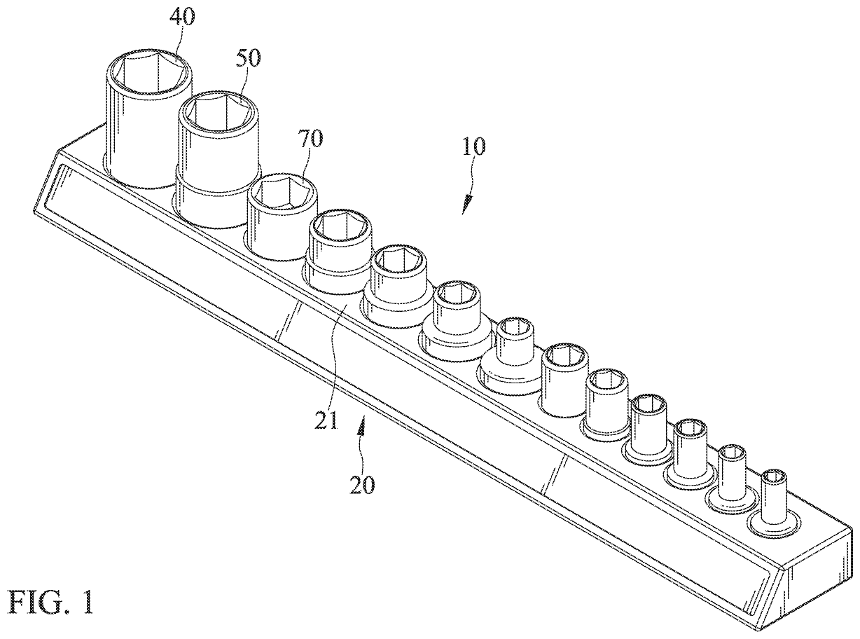

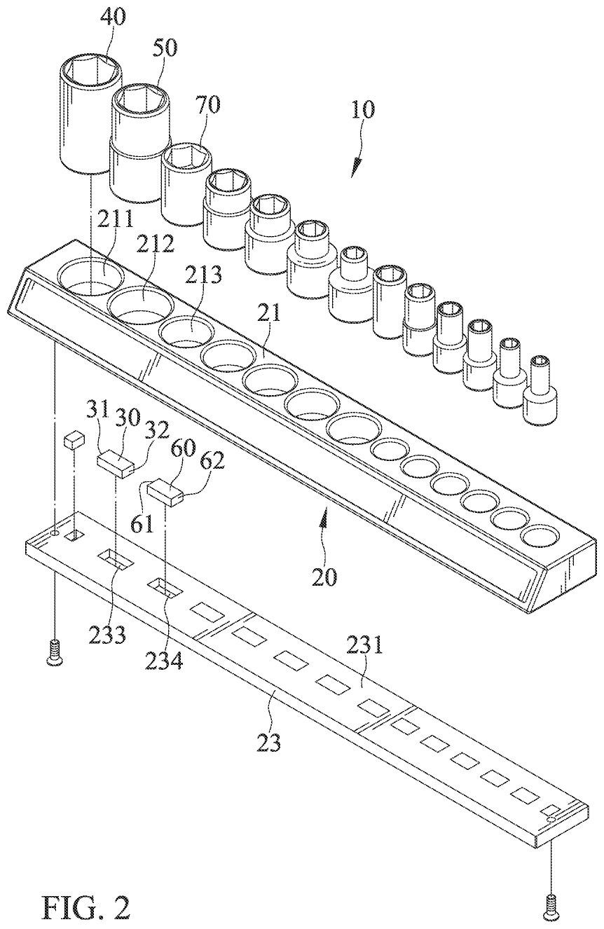

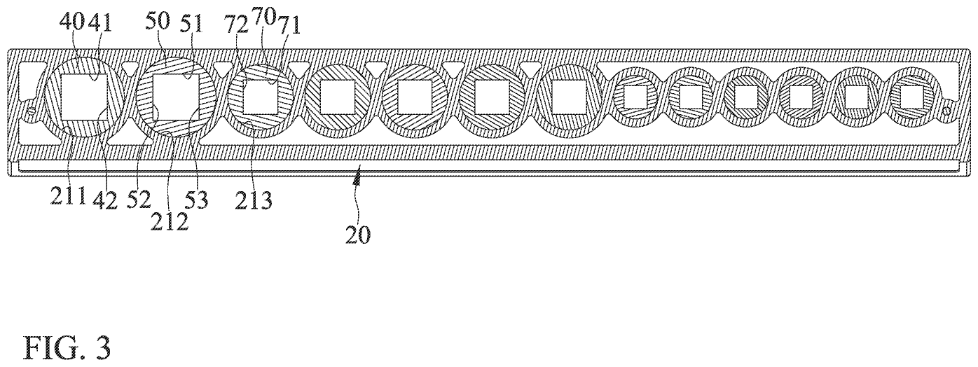

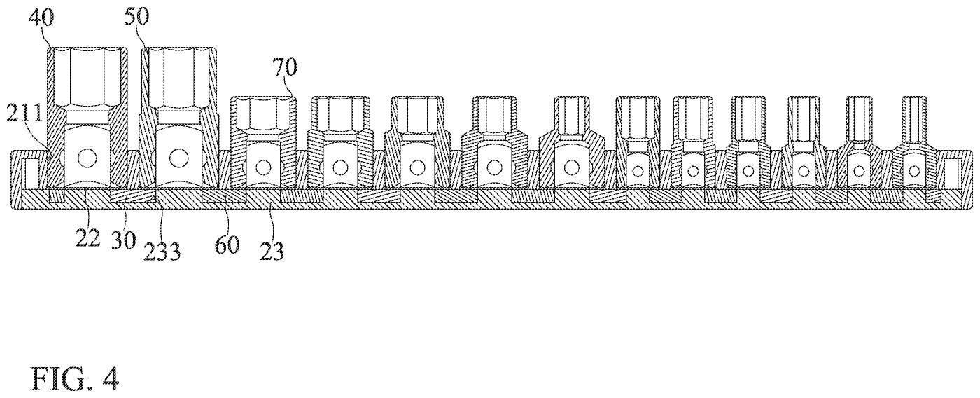

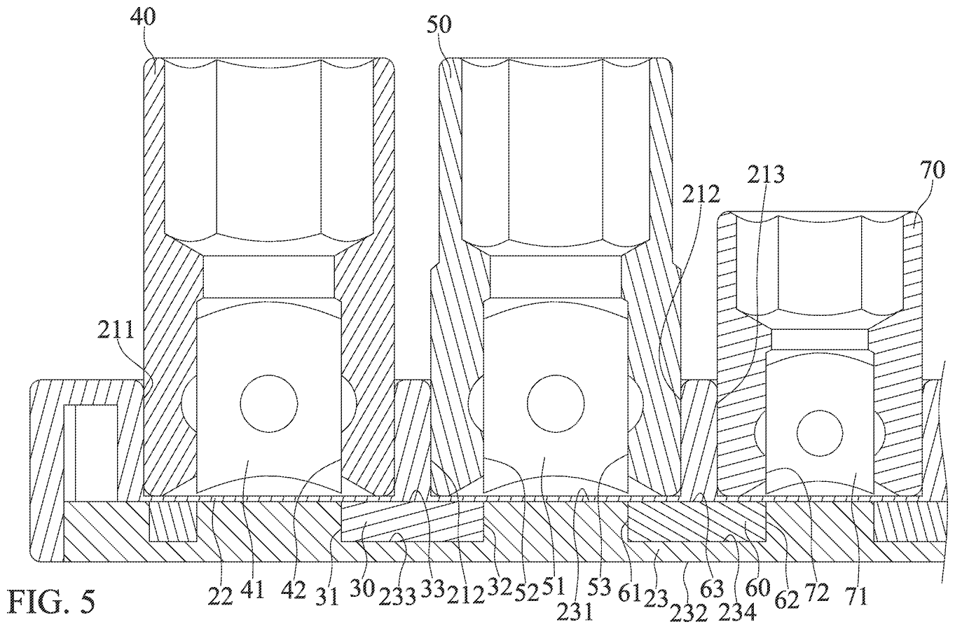

With reference to FIGS. 1-5, a magnetic socket holder 10 of an embodiment according to the present invention includes a base 20, a bottom board 23, a first magnet 30, and a first socket 40. The base 20 has a top portion 21 and a bottom portion 22. The top portion 21 includes a first insertion hole 211 and a second insertion hole 212, and each of the first insertion hole 211 and the second insertion hole 212 extends from the top portion 21 towards the bottom portion 22 and does not penetrate through the bottom portion 22. The bottom board 23 is mounted to the bottom portion 22 of the base 20 and has a top edge 231, a bottom edge 232, and a first recess 233 formed on the top edge 231 and not penetrating the bottom edge 232. The first magnet 30 is mounted in the first recess 233 and has a first side 31 located between the first insertion hole 211 and the bottom edge 232 and a second side 32 located between the second insertion hole 212 and the bottom edge 232. The first socket 40 is detachably attached in the first insertion hole 211 and has a first connection hole 41 with a first inner wall 42 aligned with the first side 31 of the first magnet 30 in a width direction.

The magnetic socket holder 10 may further include a second socket 50 detachably attached in the second insertion hole 212 and having a second connection hole 51 with a second inner left wall 52 aligned with the second side 32 of the first magnet 30 in the width direction, Thus, the first magnet 30 can concurrently magnetic attract the first socket 40 and the second socket 50.

The top portion 21 of the base 20 further includes a third insertion hole 213 extending from the top portion 21 towards the bottom portion 22 and does not penetrate through the bottom portion 22. The bottom board 23 further has a second recess 234 formed on the top edge 231 and not penetrating the bottom edge 232. The magnetic socket holder 10 further includes a second magnet 60 mounted in the second recess 234 and having a third side 61 located between the second insertion hole 212 and the bottom edge 232 and a fourth side 62 located between the third insertion hole 213 and the bottom edge 232. The second connection hole 51 further has a second inner right wall 53 faced to the second inner left wall 52 and aligned with the third side 61 of the second magnet 60 in the width direction.

The magnetic socket holder 10 may further include a third socket 70 detachably attached in the third insertion hole 213 and having a third connection hole 71 with a third inner wall 72 aligned with the fourth side 62 of the second magnet 60 in the width direction. Thus, the second magnet 60 can concurrently magnetic attract the second socket 50 and the third socket 70.

In the embodiment, the first magnet 30 further has a first upper edge 33 located between the first side 31 and the second side 32, and the second magnet 60 further has a second upper edge 63 located between the third side 61 and the fourth side 62. The first upper edge 33 and the second upper edge 63 are configured to flush with the top edge 231 of the bottom board 23 in a height direction.

In use of the magnetic socket holder 10 according to the present invention, the magnetic socket holder 10 can securely attract the sockets 40, 50 and 70 through the above structure. Due to provision of the first magnet 30 extending across the first insertion hole 211 and the second insertion hole 212, the strongest portion of the magnetic field generated by the first magnet 30 is located at the marginal portions of the first insertion hole 211 and the second insertion hole 212. When the first socket 40 and the second socket 50 are placed into the first insertion hole 211 and the second insertion hole 212, the metal portions of the first socket 40 and the second socket 50 is aligned with the first magnet 30 to provide the best magnetic attraction effect.

Furthermore, the first inner wall 42 of the first connection hole 41 of the first socket 40 is aligned with the first side 31 of the first magnet 30, and the second inner left wall 52 of the second connection hole 51 of the second socket 50 is aligned with the second side 32 of the first magnet 30 in the to width direction to reduce the amount and the size of magnets 30 and 60 being used.

Although specific embodiments have been illustrated and described, numerous modifications and variations are still possible without departing from the scope of the invention. The scope of the invention is limited by the accompanying claims.

1. A magnetic socket holder comprising:
a base having a top portion and a bottom portion, wherein the top portion includes a first insertion hole and a second insertion hole, and wherein each of the first insertion hole and the second insertion hole extends from the top portion towards the bottom portion and does not penetrate through the bottom portion;
a bottom board mounted to the bottom portion and haying a top edge, a bottom edge, and a first recess formed on the top edge and not penetrating the bottom edge;
a first magnet mounted in the first recess and having a first side located between the first insertion hole and the bottom edge and a second side located between the second insertion hole and the bottom edge; and
a first socket detachably attached in the first insertion hole and having a first connection hole with a first inner wall aligned with the first side of the first magnet in a width direction.

2. The magnetic socket holder as claimed in claim 1, further comprising:
a second socket detachably attached in the second insertion hole and having a second connection hole with a second inner left wall aligned with the second side of the first magnet in the width direction.

3. The magnetic socket holder as claimed in claim 2, wherein the top portion further includes a third insertion hole extending from the top portion towards the bottom portion and does not penetrate through the bottom portion, wherein the bottom board further has a second recess formed on the top edge and not penetrating the bottom edge, with the magnetic socket holder further comprising:
a second magnet mounted in the second recess and having a third side located between the second insertion hole and the bottom edge and a fourth side located between the third insertion hole and the bottom edge, and wherein the second connection hole further has a second inner right wall faced to the second inner left wall and aligned with the third side of the second magnet in the width direction.

4. The magnetic socket holder as claimed in claim 3, further comprising:
a third socket detachably attached in the third insertion hole and having a third connection hole with a third inner wall aligned with the fourth side of the second magnet in the width direction.

5. The magnetic socket holder as claimed in claim 4, wherein the first magnet further has a first upper edge, wherein the second magnet further has a second upper edge, and wherein the first upper edge and the second upper edge are configured to flush with the top edge of the bottom board in a height direction.
